(19) United States
(12) Patent Application Publication
(10) Pub. No.: US 2018/0039918 A1
(43) Pub. Date: Feb. 8, 2018

(54) Notification Server, Notification Method and Notification Program

(71) Applicant: KOGA Software Company, Tokyo (JP)

(72) Inventors: Shoji KOGA, Tokyo (JP); Atsushi HANEDA, Tokyo (JP); Yoshihiro FUJITA, Tokyo (JP)

(73) Assignee: KOGA Software Company, Tokyo (JP)

(21) Appl. No.: 15/308,733

(22) PCT Filed: Jan. 29, 2016
(86) PCT No.: PCT/JP2016/000475

§ 371 Date: Nov. 3, 2016

(30) Foreign Application Priority Data
May 1, 2015 (JP) 2015-093773

(51) Int. Cl. G06Q 10/02; G08G 1/127; G06Q 50/30

(52) U.S. Cl. CPC G06Q 10/02; G06Q 50/30; G08G 1/127; G06Q 10/1095

(57) ABSTRACT

A notification server, notification method and notification program to perform watch over a person to be watched who uses on-demand transportation. A transceiver part receives boarding/alighting information comprised of a date and time of boarding/alighting, a stopping point of a vehicle and a name of a boarding person or a name of alighting person transmitted from an information terminal apparatus mounted on a shared vehicle, and a notification information generating part acquires a notifying destination associated with the received name of the boarding person or the name of the alighting person from a notifying destination storage part and generates notification information addressing to the acquired notifying destination, and a transceiver part transmits the generated notification information.

### DETAILED DESCRIPTION OF THE INVENTION

### Technical Field

The present invention relates to a notification server, notification method and notification program.

### BACKGROUND

In recent years, there are increasing numbers of cities, towns and villages introducing on-demand transportations to assist transportation of elderly people who don't drive by themselves and also people who live in rural areas where means of public transportation is scarce. On-demand transportation is a public transportation such as buses and taxis that passengers can board and alight at their convenient places instead of predetermined stops, and operate on flexible time schedule according to reservations made by users. In on-demand transportation as explained above, an operation schedule is determined according to the reservations made by the users, and thus there is a need to produce an operation schedule that enables traveling of routes efficiently with less waste.

As some of the techniques to produce efficient operation schedule for on-demand transportation, a technique to produce optimal operation schedule by calculating evaluation value using the shortest route between 2 points chosen arbitrarily and time required to travel such shortest route (refer to Patent Reference 1), and a technique to amend operation schedule when the delay time produced from stopping at the users' desired boarding and alighting places is less than the predetermined buffer time (refer to Patent Reference 2) are disclosed.

### PRIOR ART

### Patent Publications

Patent reference 1 JP Patent Publication No. 2002-140788

Patent reference 1 JP Patent Publication No. 2013-186541

### SUMMARY

### Problems to be Solved

Users of such on-demand transportation consist mostly of elderly people, and in recent years, importance for local communities and public institutions to be able to acknowledge situations of elderly people's daily lives, in other words importance to watch over the situations of elderly people is pointed out. Further, there are increasing demands for families to watch their elderly family members living far away as closely as possible. Due to such growing social demands, technologies to conduct watch of person to be watched including elderly people utilizing on-demand transportations that are frequently used by elderly people are hoped for.

The present invention is invented reflecting on the matters discussed above, and aims to provide a notification server, notification method and notification program that are able to conduct watch of a person to be watched who use on-demand transportation.

### Means to Solve the Problem

To solve the above mentioned problem, the present invention is characterized in receiving boarding/alighting information consisting of the date and time of the boarding/alighting, the stopping points of the vehicle, the name of the boarding passenger and the name of the alighting passenger transmitted from the said information terminal apparatus mounted on a vehicle of which the operation schedule and stopping points can be flexibly changed according to a reservation made by a user, determining whether or not the said name of the boarding passenger included in the said boarding/alighting information and the said name of the boarding passenger stored in an operation schedule storage means that is associated with the said date and time of the boarding/alighting and the said stopping point of the vehicle included in the said boarding/alighting information match, and in the case where the names of the passenger do not match, generating notification information including a fact that the passenger did not board the vehicle according to the reservation, the reservation information and the boarding/alighting information addressed to a notifying destination, and transmits the generated notification information.

### Effect of the Invention

According to the invention comprised as above, it becomes possible to watch over a person to be watched utilizing on-demand transportation.

### BRIEF DESCRIPTION OF THE FIGURES

FIG. 1 is a diagram showing an operation management system 10 according to a first embodiment.

FIG. 2 is a block diagram showing the structure of an operation management server 100 according to the first embodiment.

FIG. 3 is an explanatory drawing showing an example of data configuration of a reservation information storage part 110.

FIG. 4 is an explanatory drawing showing an example of data configuration of an operation schedule storage part 120.

FIG. 5 is an explanatory drawing showing an example of data configuration of a boarding/alighting information storage part 130.

FIG. 6 is an explanatory drawing showing an example of data configuration of a notifying destination storage part 140.

FIG. 7 is a flowchart showing an operation schedule generation processing steps performed by the operation management server 100.

FIG. 8 is a flowchart showing notification processing steps performed by the operation management server 100, information terminal apparatus 200 and information terminal apparatus 300.

FIG. 9 is an explanatory drawing showing an example of a screen displaying an operation schedule.

FIG. 10 is an explanatory drawing showing an example of data configuration of a notifying destination storage part 140 according to a second embodiment.

FIG. 11 is a flowchart showing the operation schedule generation processing steps performed by the operation management server 100 according to the second embodiment.

FIG. 12 is a block diagram showing configuration of an operation management server 500 according to a third embodiment.

FIG. 13 is an explanatory drawing showing an example of data configuration of a provided information storage part 550 according to the third embodiment.

FIG. 14 is a flowchart showing the operation schedule generation processing steps performed by the operation management server 500.

FIG. 15 is a block diagram showing configuration of an operation management server 600 according to a fourth embodiment.

FIG. 16 is a flowchart showing the operation schedule generation processing steps performed by the operation management server 600.

### EMBODIMENTS FOR THE INVENTION

Embodiments of the present invention are described herein below with reference to the accompanying drawings. However, descriptions mentioned below are mere examples of the embodiments, and the present invention shall not be limited only to those embodiments.

### First Embodiment

FIG. 1 is a configuration diagram of an operation management system 10 according to a first embodiment. As shown in FIG. 1, the operation management system 10 interconnects an operation management server 100, an information terminal apparatus 200 operated by a watcher 2, an information terminal apparatus 300 mounted on an on-demand bus 20 and an information terminal apparatus 400 operated by an operator 3 to be communicable with each other via network N. The network N is a communication network such as internet, intranet, LAN (Local Area Network) and mobile communication network, which is formed partially or completely wired or wireless.

The operation management server 100 is an example of a server apparatus that manages the operation schedule of the on-demand bus 20 in accordance to the reservation information made by the users including a person to be watched 1 and also transmits notification information to a notifying destination generated on the basis of boarding/alighting information of a person to be watched 1.

In the present application, the term “a person to be watched 1” indicates a person who requires watch such as elderly people. However, user who board and alight from the on-demand bus 20 does not necessarily be a person to be watched 1, and it may include people who do not require a watch. A watcher 2 is a person who watches over the person to be watched 1, who may be a family, relative, local welfare commissioner, care manager and like. Further, the on-demand bus 20 is a shared bus that can flexibly change the places to stop and operation time in accordance to a reservation made by the user, and moreover taxi and other vehicles can be used instead of bus.

The information terminal apparatus 200 is a smart-phone, a personal computer (herein after called PC), a tablet terminal, a game machine or other information processing apparatus operated by the watcher 2, which accepts entry of reservation information of the on-demand bus 20 that the watcher 2 is requested via phone and like by the person to be watched 1, and further receives the notification information regarding the person to be watched 1 sent from the operation management server 100.

The information apparatus 300 is a PC, a tablet terminal, a navigation device or other information processing apparatus mounted on the on-demand bus 20, which receives and displays the operation schedule sent from the operation management server 100, while receiving entry of information regarding the users that board alight from the on-demand bus 20 and transmitting it to the operation management server 100. The information terminal apparatus 300 can either be fixed to the on-demand bus 20 or be removable from the on-demand bus 20.

The information terminal apparatus 400 is a PC, a tablet terminal or other information processing apparatus operated by the operator 3, which receives entry of the reservation information of the on-demand bus 20 requested from the person to be watched 1 via phone and the like.

Referring to the FIG. 1, flow of the overall process of the operation management system 10 according to the present embodiment is described. The person to be watched 1 requests a reservation for the on-demand bus 20 to the watcher 2 or the operator 3 by making a phone call, sending a facsimile or meeting face to face. In such ways, the person to be watched is able to make a reservation for the on-demand bus 20 even if he/she is not good at operating information appliances, while watch of the person can be performed by the watcher 2 or the operator 3 from such communication.

According to the operation by the watcher 2 or the operator 3, the information terminal apparatus 200 or the information terminal apparatus 400 accepts an entry of the reservation information of the person to be watched 1 and transmits the accepted information to the operation management server 100. The operation management server 100 generates an operation schedule from the reservation information and transmits the generated operation schedule to the information terminal apparatus 300 mounted on the on-demand bus 20.

While displaying the operation schedule, the information terminal apparatus 300 accepts information regarding the user that got aboard and alighted from the bus (hereinafter called boarding/alighting information) and transmits the accepted boarding/alighting information to the operation management server 100 when the person to be watched 1 actually got aboard the on-demand bus 20. The operation management server 100 compares the boarding/alighting information and the reservation information (to be specific, the operation schedule generated from the reservation information), generates notification information based on a result of the comparison and transmits the generated notification information to the information terminal apparatus 200 of the watcher 2.

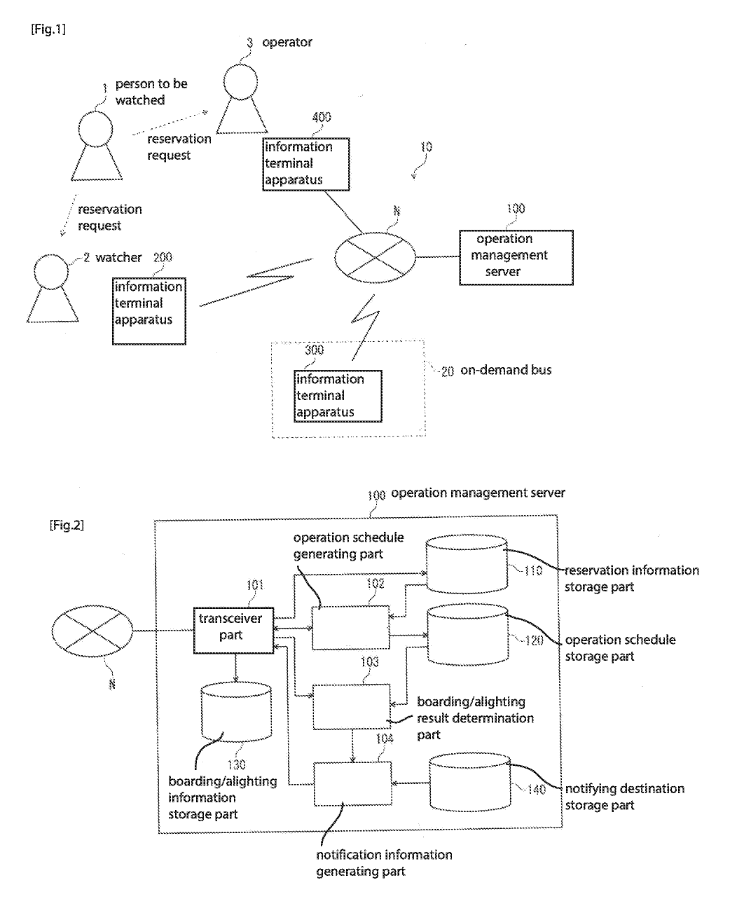

FIG. 2 is a block diagram showing a configuration of the operation management server 100 according to the first embodiment. The operation management server 100 is provided with a transceiver part 101, an operation schedule generating part 102, a boarding/alighting record determination part 103, a notification information generating part 104, a reservation information storage part 110, an operation schedule storage part 120, a boarding/alighting information storage part 130 and a notifying destination storage part 140.

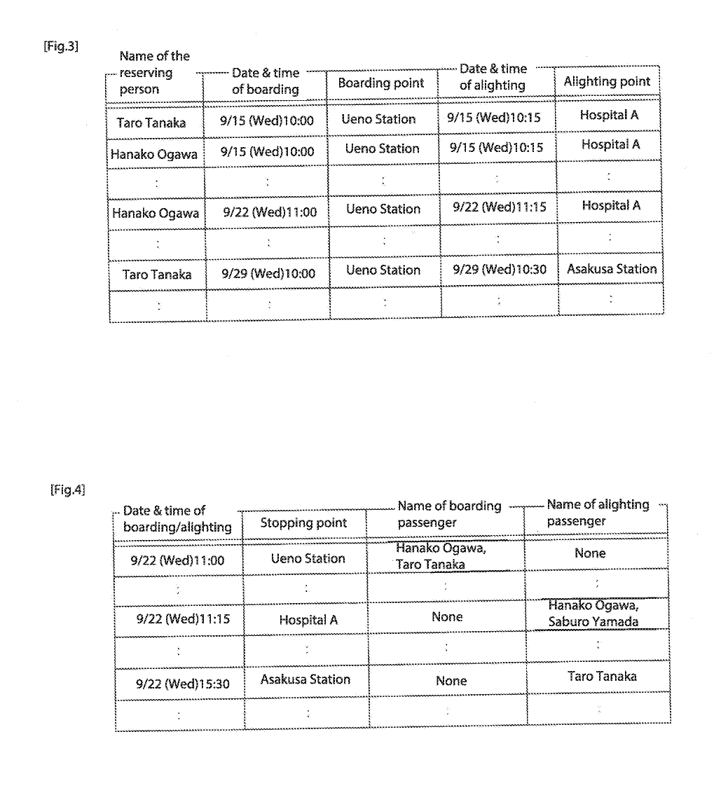

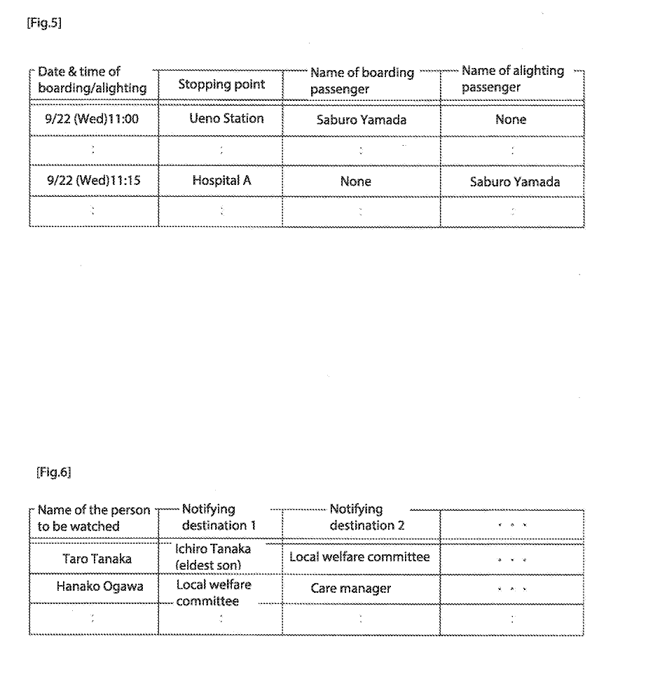

FIG. 3 is an explanatory drawing showing an example of a data configuration of the reservation information storage part 110. The reservation information storage part 110 stores the reservation information accepted from the users of the on-demand bus 20. The reservation information storage part 110 stores the reservation information that associates a name of a reserving person, date and time of boarding, a boarding point, date and time of alighting and an alighting point. The name of the reserving person is an information used to identify the user who made reservation, and hence it does not necessary be a name, and ID or code can be used instead.

FIG. 4 is an explanatory drawing showing an example of a data configuration of the operation schedule storage part 120. The operation schedule storage part 120 stores the operation schedule generated from the reservation information. The operation schedule storage part 120 stores the date and time of the boarding/alighting, the stopping point of the bus, the name of the boarding passenger and the name of the alighting passenger in association with one another.

FIG. 5 is an explanatory drawing showing an example of a data configuration of the boarding/alighting information storage part 130. The boarding/alighting information storage part 130 stores the boarding/alighting information sent from the information terminal apparatus 300 mounted on the on-demand bus 20. The boarding/alighting information storage part 130 stores the date and time of boarding/alighting, the stopping points of the bus, the name of the boarding passenger and the name of the alighting passenger in association with one another.

FIG. 6 is an explanatory drawing showing an example of a data configuration of the notifying destination storage part 140. The notifying destination storage part 140 stores the notifying destination to transmit the notification information for each person to be watched. The notifying destination storage part 140 stores the name of the person to be watched and one or more notifying destination in association to one another. To be specific, information to be stored as the notifying destination would be mail addresses and phone numbers.

The transceiver part 101 receives the reservation information sent from the information terminal apparatus 200 of the watcher 2 or the information terminal apparatus 400 of the operator 3. The transceiver part 101 transmits the operation schedule to the information terminal apparatus 300 mounted on the on-demand bus 20 and receives the boarding/alighting information from the information terminal apparatus 300 of the on-demand bus 20. Further, the transceiver part 101 transmits the notification information to the information terminal apparatus 200 of the watcher 2.

The operation schedule generating part 102 generates the operation schedule of the on-demand bus 20 employing the reservation information stored in the reservation information storage part 110. To be more specific, the operation schedule generating part 102 calculates a route which enables to operate on the date and time of boarding, the boarding point, the date and time of alighting, the alighting point for each name of the reserved person based on the reservation information stored in the reservation information storage part 110 by the predetermined time, and generates an operation schedule to follow the route. The operation schedule generating part 102 stores the generated operation schedule in the operation schedule storage part 120.

The boarding/alighting result determination part 103 compares the boarding/alighting information received from the information terminal apparatus 300 mounted on the on-demand bus 20 and the operation schedule stored in the operation schedule storage part 120. To be specific, the boarding/alighting result determination part 103 determines whether the name of the boarding passenger included in the boarding/alighting information matches the name of the boarding passenger of the operation schedule that corresponds to the date and time of boarding/alighting and the boarding point included in the boarding/alighting information. Further, boarding/alighting record determination part 103 determines whether the name of the alighting passenger included in the boarding/alighting information matches the name of the alighting passenger of the operation schedule that corresponds to the date and time of boarding/alighting and the alighting point included in the boarding/alighting information.

The notification information generating part 104 generates notification information based on a determination result acquired from the operation schedule and the boarding/alighting information. For each person to be watched 1 who reserved or got aboard on/alighted from the bus, in the case where the boarding/alighting information and the operation schedule match, the notification information generating part 104 generates a notification information including the boarding/alighting information regarding the person to be watched 1 and the fact that the person boarded/alighted according to the reservation. For each person to be watched 1, in the case where the boarding/alighting information and the operation schedule does not match, the notification information generating part 104 generates a notification information including the boarding/alighting information regarding the person to be watched 1 and the fact that the person did not boarded/alighted according to the reservation. Also, the reservation information regarding the person to be watched 1 can be further added to the notification information.

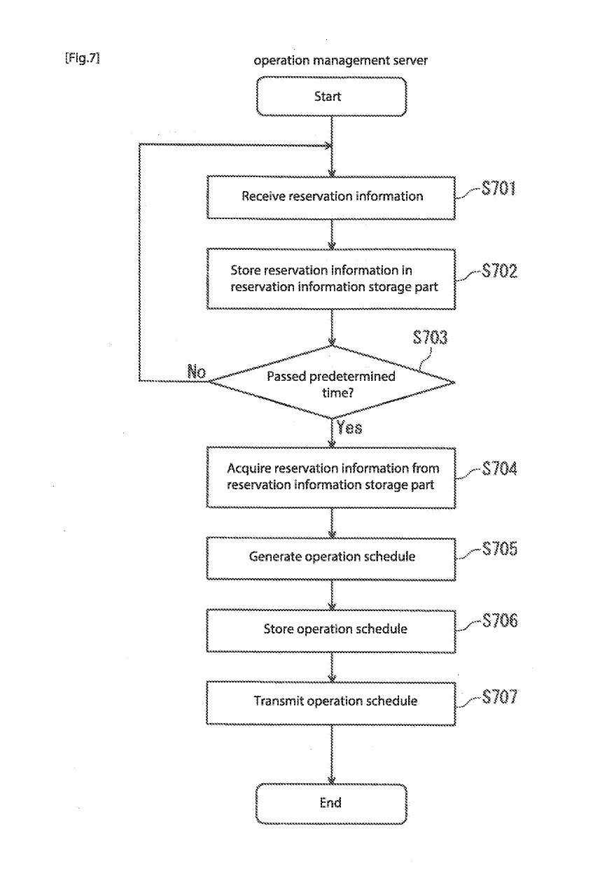

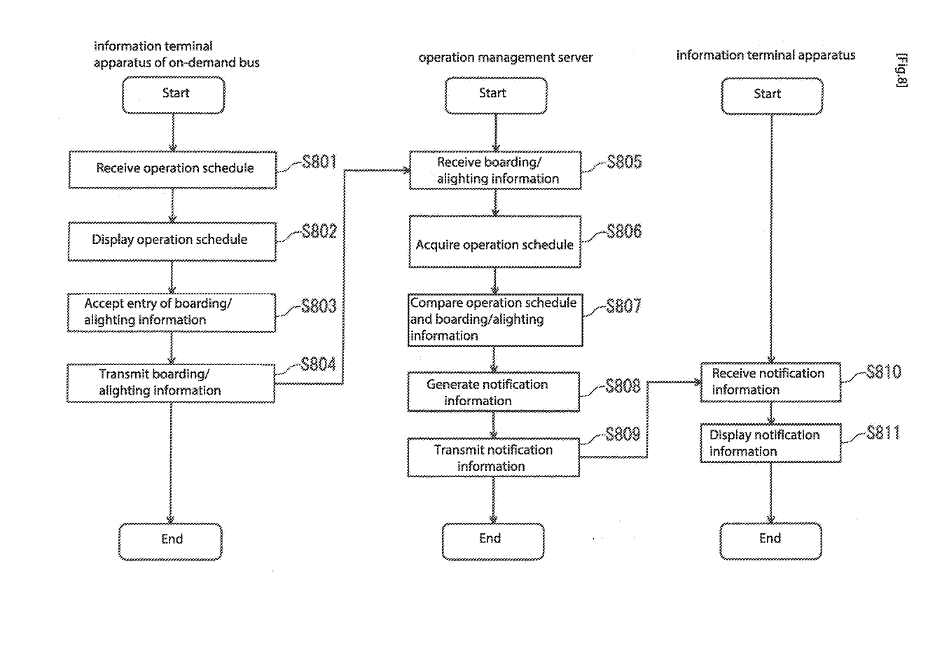

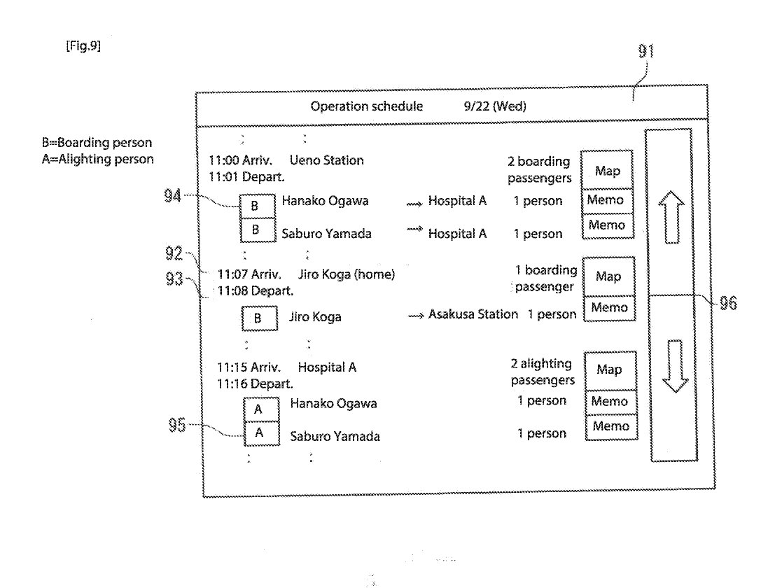

Next, the operation schedule generating process performed in the operation management server 100 of the operation management system 10 as described above will be explained. FIG. 7 is a flowchart showing the steps in the process of operation schedule generation performed in the operation management server 100.

First, the watcher 2 or the operator 3 receives details of the reservation for the on-demand bus 20 for the person to be watched 1 via phone and the like. The watcher 2 or the operator 3 then operates the information terminal apparatus 200 or the information terminal apparatus 400. The information terminal apparatus 200 or the information terminal apparatus 400 accepts the entry of the reservation information and transmits the accepted reservation information to the operation management server 100.

In the operation management server 100, the transceiver part 101 receives the reservation information sent from the information terminal apparatus 200 or the information terminal apparatus 400 (step S701). The transceiver part 101 stores the reservation information in the reservation information storage part 110 (step S702). The transceiver part 101 determines whether the predetermined time has already passed or not (step S703). The predetermined time is a time set in advance as a time of deadline to accept reservation information, for instance 15:00 on the day before the operation day, 3 hours before the operation starting time and such. In case the time is yet to pass the predetermined time (step S703: No), it goes back to the step S701 and continues to receive the reservation information.

In case the predetermined time has already passed (step S703: Yes), the operation schedule generation part 102 acquires the reservation information from the reservation information storage part 110 (step S704). The operation schedule generating part 102 generates the operation schedule from the reservation information (step S705). The operation schedule generating part 102 stores the operation schedule in the operation schedule storage part 120 (step S706). The transceiver part 101 transmits the operation schedule to the information terminal apparatus 300 mounted on the on-demand bus 20.

As above, in the process of conveying the details of the reservation for the on-demand bus 20 to the watcher 2, the person to be watched 1 has a chance to communicate with the watcher 2, and moreover, by making the watcher 2 enter the reservation information of the person to be watched 1, it becomes possible for the former to grasp the activities of the person to be watched 1.

In case the person to be watched 1 does not have a suitable watcher 2 or if the person to be watched 1 does not wish to bother the watcher 2 on every occasion of making reservation, the reservation for the on-demand bus 20 can be made by conveying the details of reservation to the operator 3.

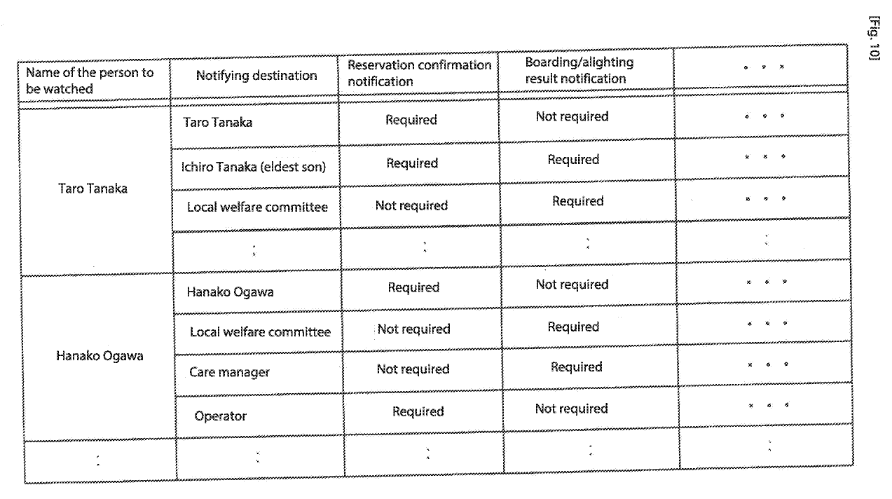

Next, a watching process performed by the operation management system 10 is described. FIG. 8 is a flowchart showing steps in notification processing performed by the operation management server 100, the information terminal apparatus 200 and the information terminal apparatus 300.

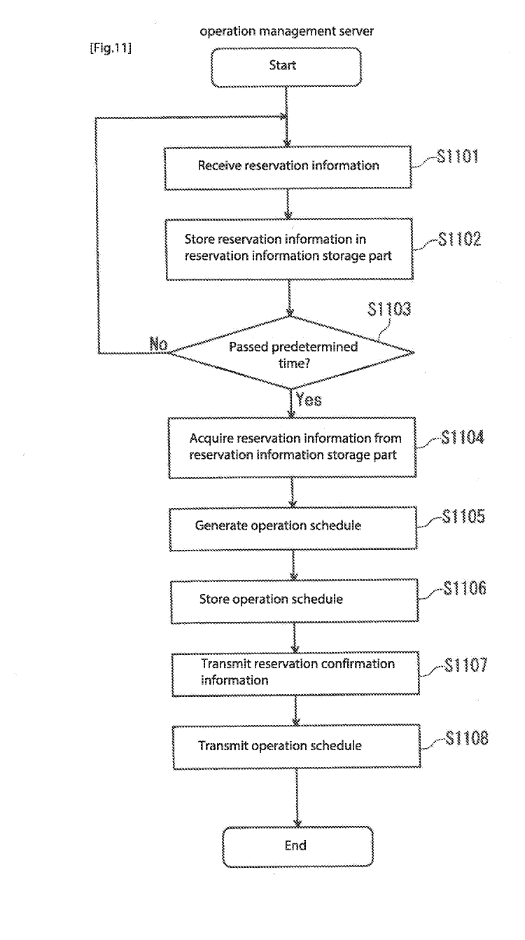

The information terminal apparatus 300 mounted on the demand bus 20 receives the operation schedule sent from the operation management server 100 (step S801). The information terminal apparatus 300 displays the operation schedule on the display part (step S802). FIG. 9 is an explanatory drawing showing an example of the screen displaying the operation schedule. As shown in FIG. 9, date of operation 91, time of arrival 92, time of departure 93, names of the boarding passengers 94, names of the alighting passengers 95 and the place where the on-demand bus 20 is currently running 96 is displayed as the operation schedule.

The information terminal apparatus 300 accepts the entry of the boarding/alighting information (step S803). To be more specific, the information terminal apparatus 300 accepts the entry of the boarding/alighting information by tapping on the name of the boarding passenger or the name of the alighting passenger on the touch panel that displays the operation schedule. Alternatively, the person to be watched 1 can use a contactless IC card and such that utilizes RFID (Radio Frequency Identification) technology to enter the boarding/alighting information by holding the IC card over an IC card reader. The boarding/alighting information can also be accepted by receiving information that determines the person to be watched 1 sent from a beacon terminal carried by the person to be watched 1 by the information terminal apparatus 300. The information terminal apparatus 300 transmits the accepted boarding/alighting information to the operation management server 100 at every stopping point (step S804). Even when there is no boarding or alighting passenger at the stopping point, the information including the date and time of the boarding/alighting, the stopping point of the bus, “none” as a name of the boarding passenger and “none” as a name of the alighting passenger is sent.

The transceiver part 101 of the operation management server 100 receives the boarding/alighting information sent from the information terminal apparatus 300 mounted on the on-demand bus 20 (step S805). The boarding/alighting result determination part 103 acquires the operation schedule that corresponds to the boarding/alighting information from the operation schedule storage part 120 (step S806). For example, when the boarding/alighting information including a date and time of boarding/alighting ‘September 22 (Wed.) 11:00’, a stopping point ‘Ueno station’, a name of the boarding passenger Saburo Yamada as illustrated in FIG. 5, is received, names of the boarding/alighting passenger ‘Hanako Ogawa, Saburo Yamada’ that correspond to the date and time of boarding/alighting ‘September 22 (Wed.) 11:00’ and place to stop ‘Ueno station’ are acquired. If the date and time of boarding/alighting included in the boarding/alighting information corresponds to the date and time that the person to be watched 1 actually used the on-demand bus 20, the operation schedule is acquired with predetermined range of time.

The boarding/alighting result determination part 103 compares the boarding/alighting information and the operation schedule (step S807). In the example explained above, since “Saburo Yamada” is included in both the boarding/alighting information and the operation schedule as a passenger, it is determined that he got on the bus according to the reservation. On the other hand, “Hanako Ogawa” is included in the operation schedule but not in the boarding/alighting information as a passenger, thus it is determined she did not get on the bus as reserved according to the reservation.

The notification information generating part 104 generates the notification information according to the determination result by the boarding/alighting result determination part 103 (step S808). To be specific, the notification information generating part 104 acquires the notifying destination that corresponds to the name of the boarding passenger or the name of the alighting passenger from the notifying destination storage part 140, and generates notification information addressed to the acquired destination. The contents of the notification information include the fact that the person did or did not board/alight the bus according to the reservation, the boarding/alighting information, and may also include the reservation information. The notification information can be generated in both cases when the person boarded/alighted as reserved and when the person did not board/alight as reserved or can be generated only when the person did not board/alight as reserved.

The transceiver 101 transmits the notification information to the notifying destination (step S809). As a means to transmit the notification information, various means can be used such as an e-mail transmission, a push notification using SMS (Short Message Service) function and the like, and an automatic voice call that transmits voice reading out the contents of notification via telephone line.

The information terminal apparatus 200 of the notifying destination receives the notification information sent from the operation management server 100 (step S810). The information terminal apparatus 200 displays the notification information on the displaying part (step S811). In case the notification is made by voice, the voice is outputted from a speaker.

By having the notification information sent to the notifying destination as explained above, it becomes possible for the watcher 2 to grasp the situation without imposing a big burden on the person to be watched 1 and the watcher 2 in either cases when the person to be watched 1 boarded on the on-demand bus 20 as reserved and when the person to be watched 1 did not board as reserved. Moreover, it becomes possible for the families living far way, the local welfare committee and the public organizations to recognize whether the person to be watched is leading a daily life without problem or something irregular is happening, and able to watch over the person to be watched 1 on a daily basis. Further, when the person to be watched 1 did not get on the on-demand bus 20 as reserved, watchers are able to grasp the possibility of injury, illness and such without being informed by the person to be watched 1, thus becomes possible to perform watch over the person to be watched 1 more closely.

Conventionally, as inventions to grasp the abnormality in health status of the elderly, numerous technologies have been developed to notify any status when there is danger in life of the elderly by, for example, sending alarms when activities of the elderly cannot be detected by a sensor. However, with these conventional technologies, it was not possible to grasp abnormalities that develop gradually, such as in case of dementia where the person to be watched forgets the contents of reservation that was made by oneself. In regards to such problem, it becomes possible to grasp the change in cognitive degree of the person to be watched 1 by transmitting notifications of the difference between the contents of reservation and the actual boarding/alighting result with the above described technology. Thus, by utilizing the above described technology, it becomes possible to prevent symptoms to advance its severity by being able to deal with dementia in an early stage, which also helps in suppressing the increase of the people requiring caretaking.

In the above mentioned embodiment, the reservation of on-demand bus 20 is accepted by the information terminal apparatus 200 or the information terminal apparatus 400 by having the person to be watched 1 requesting the reservation of the on-demand bus 20 to the watcher 2 or the operator 3 instead of operating the information terminal apparatus such as smart phone by oneself, however, in case the person to be watched is able to operate the information terminal apparatus, the entry of reservation information can be accepted from the information terminal apparatus owned by the person to be watched 1.

In another embodiment of the invention, the received boarding/alighting information can be sent to the notifying destination without performing comparison of the boarding/alighting information and the operation schedule at the boarding/alighting result determination part 103 when the boarding/alighting information sent from the information terminal apparatus 300 on the on-demand bus 20 is received by the transceiver part 101.

### Second Embodiment

Next, in addition to the processes in the first embodiment, processes of a second embodiment that transmits the contents of reservation of the person to be watched 1 to the notifying destination in advance as reservation confirmation information are described.

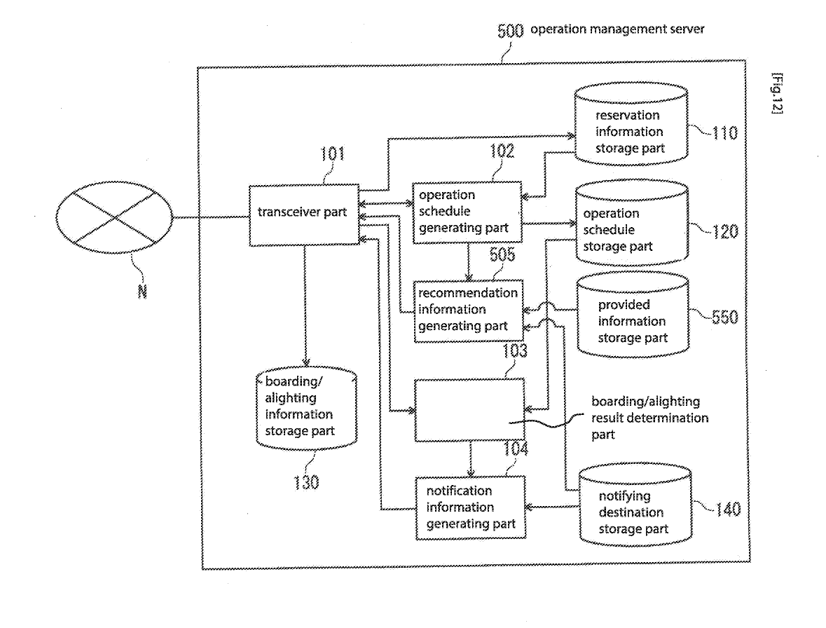

FIG. 10 is an explanatory drawing showing an example of data configuration of notifying destination storage part 140 according to the second embodiment. The notifying destination storage part 140 stores the notifying destination to transmit the notification information for each person to be watched 1. The notifying destination storage part 140 stores the name of the person to be watched 1, the notifying destination, whether the reservation confirmation notification is required or not and whether the boarding/alighting result notification is required or not in association to one another.

Now, a process of operation schedule generation performed in the operation management server 100 of the operation management system 10 according to the second embodiment is described. FIG. 11 is a flowchart showing steps in the operation schedule generation process performed by the operation management server 100 of the second embodiment. The processes of step S1101 to step S1106 and step S1108 in the steps of the operation schedule generation process will not be explained in details here since they are similar to the step S701 to step S707 in FIG. 7, of which the description should be referred to.

The transceiver 101 transmits the reservation confirmation information (step S1107). More specifically, the reservation confirmation information including the date and time of boarding, the boarding point, the date and time of alighting and the alighting point is acquired from the operation schedule for each passenger included in the operation schedule, and out of all the notifying destinations stored in the notifying destination storage part 140, the information is sent to the notifying destination with “required” stored under the reservation confirmation notification column. For example, out of the notifying destinations of the person to be watched “Taro Tanaka” in FIG. 10, the information is sent to “Taro Tanaka (the person to be watched 1)” and “Ichiro Tanaka (the eldest son)”. On the other hand, the reservation confirmation notification will not be sent to the notifying destination “local welfare committee”, but the boarding/alighting notification, in other words the notification information in step S809 of FIG. 8 will be sent thereto.

Further, the date and time of transmission and the timing of transmission of the reservation confirmation information can be decided in advance aside from when the operation schedule is generated, for example at 21:00 on the day before the boarding or 30 minutes before the boarding.

As described above, by notifying the reservation confirmation information to the person to be watched 1 and the watcher 2 in advance, it is possible to prevent the person to be watched 1 from forgetting to get on the on-demand bus 20 or mistaking which bus to get on. Further, by notifying the reservation confirmation information to the watcher 2 in advance, the activities of the person to be watched 1 can be grasped and further, it will give chance for the watcher 2 to hold conversation with the person to be watched 1 for confirmation

As another embodiment, the reservation information that has been repeated more than predetermined times can be extracted from the reservation information stored in the reservation information storage part 110 for each person to be watched 1, and in case such reservation information is not accepted by the predetermined time, the reservation confirmation information can be sent to check whether or not the reservation is missed or forgotten.

Further, reservations made in the past can be extracted from the reservation information stored in the reservation information storage part 110 for each person to be watched 1, and in case the boarding point or the alighting point of the newly made reservation information is different from the past reservation information, a reservation confirmation information can be sent to confirm that the contents is different from the past reservation information.

Furthermore, the reservation information of plurality of reserved persons who have made reservations for the same date and time and same boarding/alighting points can be extracted from the past reservation information stored in the reservation information storage part 110, and in case a reservation under the name of the person from the extracted names of the reserved persons is newly accepted, reservation confirmation information can be sent to the other users if they wish to make the same reservation as the person who has newly made the reservation.

### Third Embodiment

Next, as a third embodiment, a process to transmit a recommendation information in accordance to the person to be watched 1 is explained.

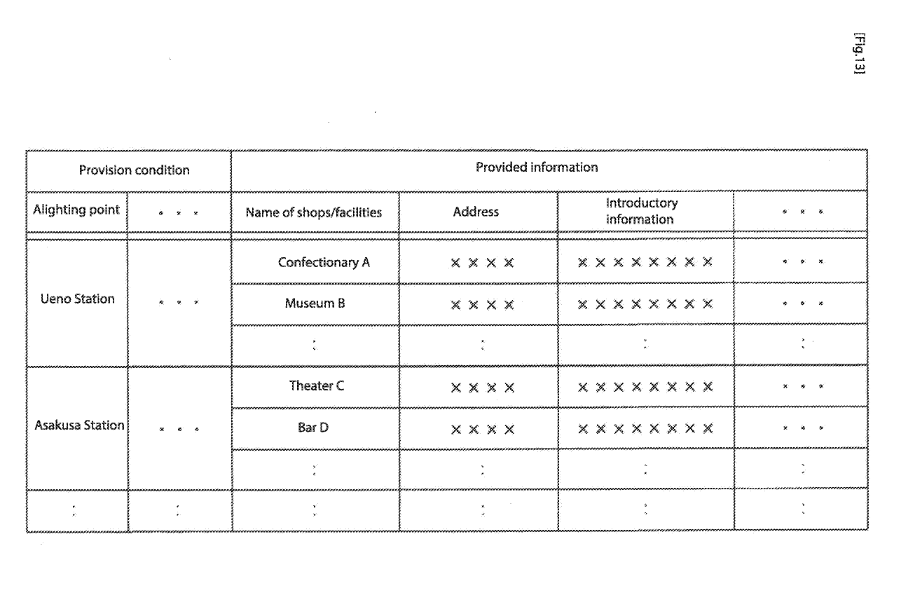

FIG. 12 is a block diagram showing a configuration of the operation management server 500 according to the third embodiment. The operation management server 500 includes a transceiver 101, an operation schedule generating part 102, a boarding/alighting result determination part 103, a notification information generating part 104, a recommendation information generating part 505, a reservation information storage part 110, an operation schedule storage part 120, a boarding/alighting information storage part 130, a notifying destination storage part 140 and a provided information storage part 550. The same numerical indications are made for the parts having the same function as the first and second embodiments, and descriptions thereof are omitted in the present embodiment.

FIG. 13 is an explanatory drawing showing an example of the data configuration of the provided information storage part 550 according to the third embodiment. The provided information storage part 550 stores provision information transmitted to the person to be watched 1 who matched the provision condition. Further, the provided information storage part 550 stores the provision condition and the provided information in association with one another. For example, as illustrated in FIG. 13, in association with the provision condition of “Ueno station” as the alighting point, the names of the shops and facilities such as “Confectionary A” and “Museum B”, their addresses, introductory information and other information are stored as provided information. Further, the provision condition can be the boarding point instead of, or in addition alighting point. Further, attribute information such as gender, age group and subject of interest of the person to be watched 1 can be added to the provision condition to enable narrowing down of the result. In such case, a storage part for associating the person to be watched 1 with the attribute information is provided.

The recommendation information generating part 505 generates recommendation information corresponding to the activities of the person to be watched 1 and the attribute information of the user. For example, the recommendation information generating part 505 acquires the provided information associated with the alighting point from the provided information storage part 550 for the person to be watched 1 who is included in the operation schedule generated by the operation schedule generating part 102 planned to be on board.

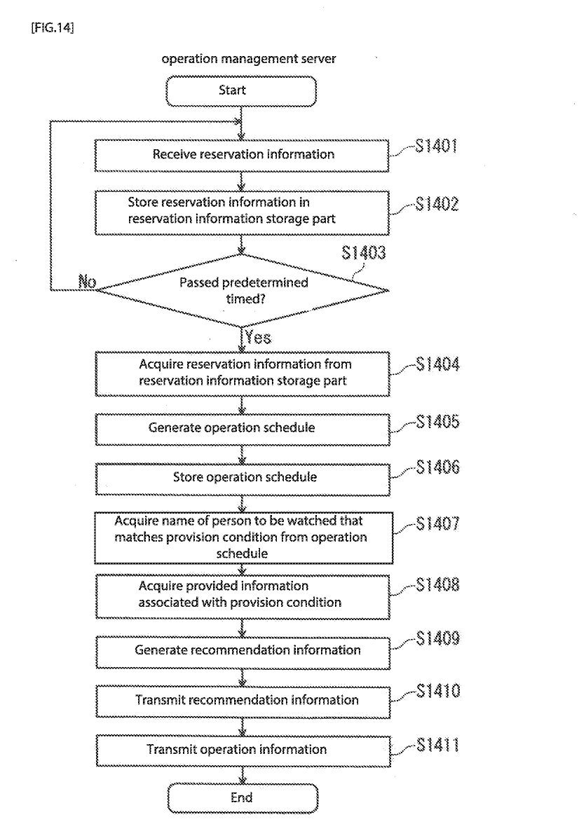

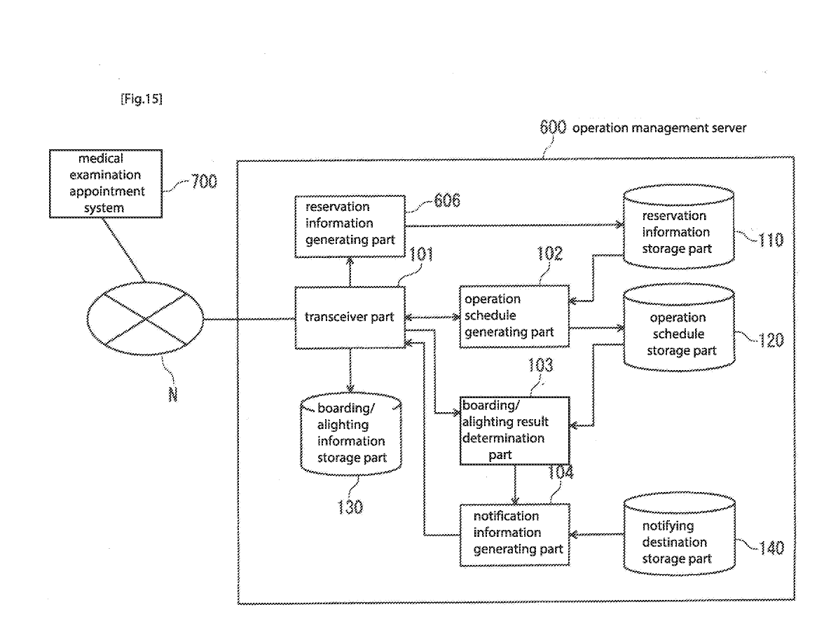

Next, the operation schedule generation process performed in the operation management server 500 according to the third embodiment is described. FIG. 14 is a flowchart showing the steps of the operation schedule generating process performed in the operation management server 500. Since processes in step S1401 to step S1406 and step S1411 in the steps of operation schedule generating process are similar to the processes in step S701 to step S707 of FIG. 7, reference is made to the explanations made above for FIG. 7 and explanations thereof are omitted in the present embodiment.

The recommendation information generating part 505 acquires the name of the person to be watched that matches the provision condition from the operation schedule (step S1407). As one example, in correspondence to the provision condition of “Asakusa station” as the alighting point in FIG. 13, the name of the person stored to alight at “Asakusa station”, which is “Taro Tanaka”, is acquired from the operation schedule as shown in FIG. 4. The recommendation information generating part 505 acquires the provided information that matches the provision condition from the provided information storage part 550 (step S1408). In the case of the example above, information of “Theater C” and “Bar D” associated with “Asakusa station” as the provision condition of the place of alighting is acquired.

The recommendation information generating part 505 generates the recommendation information (step S1409). To be more specific, the recommendation information generating part 505 generates the recommendation information addressed to the notifying destination associated with the name of the person to be watched acquired from the notifying destination storage part 140 from the provided information acquired from the provided information storage part 550. The transceiver part 101 transmits the recommendation information (step S1410). For the notifying destination storage part 140, either one in the first embodiment or the second embodiment can be used.

Further with regards to the recommendation information, other than transmitting the recommendation information alone as described above, it can also be transmitted with the reservation confirmation information as explained in the second embodiment.

As explained above, by narrowing down the information by the provision condition, it becomes possible to transmit the recommendation information corresponding to the person to be watched 1, which helps broadening the scope of activities and range of interest of the person to be watched 1, and further improves the quality of living of the person to be watched 1. Further, it gives more chance to the watcher 2 to have communication with the person to be watched 1. Moreover, for companies, shops and facilities providing the provision information, the provided information corresponding to the person to be watched 1 using the on-demand bus 20 can be transmitted as the recommendation information to the person to be watched 1 at the timing of the reservation of on-demand bus 20, in another words at the timing when the person to be watched 1 goes out, which can draw attention of the person to be watched 1 and can expect increase of customers.

The subject to whom the recommendation information is transmitted in the present embodiment does not need to be the person to be watched 1, and by registering the notifying destination in advance, all the people who use the on-demand bus 20 can be the subject of such service.

### Fourth Embodiment

Now, processes in a fourth embodiment that generates the reservation information based on the information transmitted from the external system and further generates the operation schedule utilizing the generated reservation information is described.

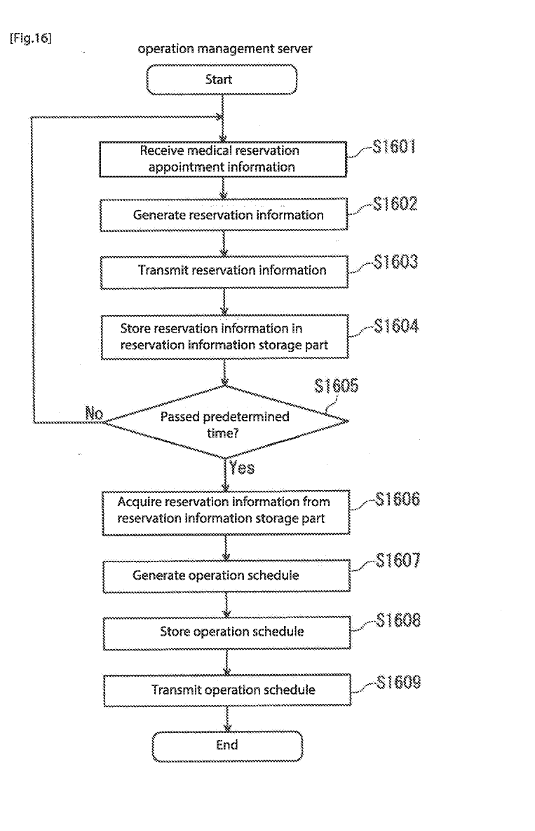

FIG. 15 is a block diagram showing the configuration of an operation management server 600 according to the fourth embodiment. The operation management server 600 is provided with a transceiver part 101, an operation schedule generating part 102, a boarding/alighting result determination part 103, a notification information generating part 104, a reservation information generating part 606, a reservation information storage part 110, an operation schedule storage part 120, a boarding/alighting information storage part 130 and a notifying destination storage part 140. The same numerical indications are made for the parts having the same function as the first, second and third embodiments, and descriptions thereof are omitted in the present embodiment.

The reservation information generation part 606 generates the reservation information of the on-demand bus 20 based on the information transmitted from an external system. To be more specific, basing on the reservation information of medical examination sent from the external system, for example a medical examination appointment system 700 operating at the hospital, the reservation information generating part 606 generates the reservation information to arrive at the hospital on the date and time to meet the appointment made for medical examination.

Next, the operation schedule generating process performed in the operation management server 600 according to the fourth embodiment is described. FIG. 16 is a flowchart showing the steps in the operation schedule generating process performed by the operation management server 600. Since processes in step S1604 to step S1609 in the steps of operation schedule generating process are similar to the processes in step S702˜step S707 of FIG. 7, reference is made to the explanations made above for FIG. 7 and explanations thereof are omitted in the present embodiment.

The transceiver part 101 receives the medical examination appointment information from the medical examination appointment system 700 (step S1601). Name of the patient, the date and time of the reservation, the place of boarding and name of the hospital are included in the medical examination appointment information. The reservation information generating part 606 generates the reservation information based on the medical examination appointment information (step S1602). In more detail, the reservation information generating part 606 generates the reservation information comprised of the name of the person making reservation, the date and time of boarding, the boarding point, the date and time of alighting and the alighting point by back calculation of the date and time of the medical examination appointment. The transceiver 101 transmits the reservation information to the medical examination appointment system (step S1603).

As described above, for the person to be watched 1 who receives medical examination at the hospital, since the reservation for the on-demand bus 20 can be made when making an appointment for the medical examination, a means for transportation to the hospital can be secured without having the person to be watched 1 to make reservation by oneself. Moreover, by linking the medical examination appointment system at the hospital with the on-demand transportation system, it becomes possible for the watcher 2 to keep an eye on the person to be watched 1 who stops going to the hospital despite the condition in need of continuous medical examination, and further enables a close watch over the person to be watched 1 to prevent progression of illness to a severe level.

Further, the external system linked to the operation management server 600 does not have to be the medical examination appointment system at the hospital, and it can be linked to reservation systems of the places that require reservation before visit such as acupuncture clinics, osteopathic clinics, sports centers, restaurants, beauty salons and barbers, which makes it easier for the person to be watched 1 to secure the means for transportation, and for the watcher 2, it enables more careful watch by grasping the activities of the person to be watched 1. Moreover, for the facilities and the shops, there is an effect of enhancing the probability of visit by the person making reservation.

Likewise in the present embodiment, the subject is not limited to the person to be watched 1, and may include all the passengers who use the on-demand bus 20.

A hardware configuration of the operation management server 100, 500 and 600 according to the first to fourth embodiment is a normal computer equipped with eternal storage devices and communication control devices such as CPU (Central Processing Unit), ROM (Read Only Memory), RAM (Random Access Memory) and HDD (Hard Disk Drive), and the configurations and the functions explained above can be realized by reading and operating the programs stored in the ROM, RAM, HDD and the like by the CPU.

The programs operated in the operation management server 100, 500 and 600 can be stored in the computer connected to a network N such as internet, and can be provided by downloading via the network N, or can be provided by recording it on a computer readable recording medium such as CD-ROM, DVD, USB memory and SD card as a file in an installable or executable format. Further, the program for realizing the functions and processes explained above can be provided in use forms such as API (Application Programming Interface), SaaS (Software as a Service) and cloud computing.

Further, the present invention is not limited only to the above mentioned embodiments and it does not require to take the configurations as shown in the drawings physically. Moreover, the present invention can be configured with all or part of the components explained in the first to fourth embodiments functionally or physically divided, integrated, replaced, deformed or deleted in an arbitrary unit depending on various loads and use situation.

### NUMERICAL INDICATIONS

N . . . network
1 . . . person to be watched
2 . . . watcher
3 . . . operator
10 . . . operation management system
100, 500, 600 . . . operation management server
101 . . . transceiver part
102 . . . operation schedule generating part
103 . . . boarding/alighting result determination part
104 . . . notification information generating part
505 . . . recommendation information generating part
606 . . . reservation information generating part
110 . . . reservation information storage part
120 . . . operation schedule storage part
130 . . . boarding/alighting information storage part
140 . . . notifying destination storage part
550 . . . provided information storage part
200, 300, 400 . . . information terminal apparatus
700 . . . medical examination appointment system

1. A notification server connected via network to an information terminal apparatus mounted on a shared vehicle capable of flexibly changing stopping point and operation time according to a reservation made by a user comprising;
a notifying destination information storage means for storing a name of the user to identify a passenger boarding/alighting the said shared vehicle and one or plurality of notifying destinations associated with the said user,
an operation schedule storage means for storing an operation schedule associating date and time of boarding/alighting, a stopping point of the vehicle, a name of boarding passenger and a name of alighting passenger,
a reservation information storage means for storing reservation information associating a name of the person making reservation for boarding/alighting of the said shared vehicle, date and time of boarding, a boarding point, date and time of alighting and an alighting point,
a receiving means for receiving the reservation information consisting of the name of the person making reservation, the date and time of boarding, the boarding point, the date and time of alighting and the alighting point, and storing the received reservation information in the said reservation information storage means,
an operation schedule generating means for calculating a route capable of operation on the basis of the said reservation information stored in the said reservation information storage means, generating an operation schedule consisting of the date and time of boarding/alighting, the stopping point of the vehicle, the name of the boarding passenger and the name of the alighting passenger to be able to travel the calculated route, and storing the generated operating schedule in the said operation schedule storage means,
the said receiving means receives boarding/alighting information consisting of the date and time of the boarding/alighting, the stopping points of the vehicle, the name of the boarding passenger and the name of the alighting passenger transmitted from the said information terminal apparatus,
a boarding/alighting result determination means for determining whether or not the said name of the boarding passenger included in the said boarding/alighting information and the said name of the boarding passenger stored in the said operation schedule storage means that is associated with the said date and time of the boarding/alighting and the said stopping point of the vehicle included in the said boarding/alighting information match,
a notification information generating means for acquiring the notifying destination associated with the said name of the user that corresponds with the said name of the boarding passenger from the said notifying destination information storage means, generating notification information including the fact that the passenger did not board the vehicle according to the reservation, the said reservation information and the said boarding/alighting information addressed to the acquired notifying destination, in case the said names of the alighting passenger were determined not to match by the said boarding/alighting result determination means, and
a transmitting means for transmitting the said notification information generated by the said notification information generating means.

2. The notification server according to claim 1, in which the said boarding/alighting result determination means determines whether or not the said name of the alighting passenger included in the said boarding/alighting information and the said name of the alighting passenger stored in the said operation schedule storage means associated with the said date and time of boarding/alighting and the said stopping point of the vehicle included in the said boarding/alighting information match,
and in the case where it was determined by the said boarding/alighting result determination means that the said names of the alighting passenger do not match, the said notification information generating means acquires the notifying destination associated with the said name of the user corresponding to the said name of the alighting passenger from the said notifying destination information storage means, and generates notification information including the fact that the passenger did not alight from the vehicle according to the reservation, the said reservation information and the said boarding/alighting information addressed to the acquired notifying destination.

3. The notification server of claim 2 in which the said notification information generating means generates notification information including the fact that the passenger did board the vehicle according to the reservation in the case where it is determined by the said boarding/alighting result determination means that the said names of the boarding passenger match.

4. The notification server of claim 3 in which the said notification information generating means generates notification information including the fact that the passenger did alight from the vehicle according to the reservation in the case where it was determined by the said boarding/alighting result determination means that the said names of the alighting passenger match.

5. The notification server of claim 4 in which the said transmitting means acquires reservation confirmation information consisting of the date and time of boarding, the boarding point, the date and time of alighting and the alighting point for each of the said name of passenger included in the said operation schedule stored in the said operation schedule storage means, and transmits the acquired reservation confirmation information.

6. The notification server of claim 5 further comprising;
a provided information storage means for storing provision condition and provided information in association with each other,
a recommendation information generating means for acquiring the said provided information associated with the said provision condition for each of the said name of the passenger included in the said operation schedule stored in the said operation schedule storage means if condition matches the said provision condition, and generating recommendation information including the acquired provided information,
wherein the said transmitting means transmits the said recommendation information.

7. The notification server of claim 6 in which the said receiving means receives external reservation information consisting of a name of the person making reservation that was accepted by the external system, a date and time of the reservation, a boarding point and an alighting point sent from an external system,
and further provided with a reservation information generating means for generating the said reservation information on the basis of the said external reservation information and storing the generated reservation information in the said reservation information storage means.

8. A method for implementing a notification process performed by a notification server comprising the following steps:
providing a notifying destination information storage means for connecting via network with an information terminal apparatus mounted on a shared vehicle capable of flexibly changing its stopping point and operation time depending on a reservation made by a user, and storing a name of the user for identifying a passenger boarding/alighting the said shared vehicle and one or plurality of notifying destinations associated with the said user,
providing an operation schedule storage means for storing operation schedule associating a date and time of boarding/alighting, a stopping point, a name of boarding passenger and a name of alighting passenger, and
providing a reservation information storage means for storing reservation information associating a name of reserving person who made the reservation for the said shared vehicle, the date and time of boarding, the boarding point, the date and time of alighting and the alighting point,
receiving reservation information consisting of a name of a reserving person, date and time of boarding, a boarding point, date and time of alighting and an alighting point, and storing the received reservation information in the said reservation information storage means,
calculating a route capable of an operation based on the said reservation information stored in the said reservation information storage means, generating an operation schedule consisting of the date and time of boarding/alighting, the stopping point, the name of the boarding passenger and the name of the alighting passenger for traveling the calculated route, and storing the generated operation schedule in the said operation schedule storage means,
receiving boarding/alighting information sent from the said information terminal apparatus consisting of date and time of boarding/alighting, stopping points, the name of the boarding passenger and the name of the alighting passenger,
determining whether or not the said name of the boarding passenger included in the said boarding/alighting information and the name of the said passenger stored in the said operation schedule storage means associated with the said date and time of boarding/alighting and the said stopping point match,
acquiring a notifying destination associated with the said name of the user corresponding to the said name of the passenger from the said notifying destination storage means and generating notification information addressed to the acquired notifying destination, including the fact that the passenger did not board according to the reservation, the reservation information and the said boarding/alighting information, in the case where it was determined by the said boarding/alighting result determination step that the said name of the passenger do not match, and
transmitting the said notification information generated in the said notification information generation step.

9. A notification program for performing below steps in a computer comprising;
providing a notifying destination information storage means for connecting via network with an information terminal apparatus mounted on a shared vehicle which is capable of flexibly changing its stopping point and operation time depending on a reservation made by a user, and storing a name of a user for identifying boarding/alighting passenger of the said shared vehicle and one or plurality of notifying destinations associated with the said user,
providing an operation schedule storage means for storing operation schedule associating date and time of boarding/alighting, stopping point, name of the boarding passenger and name of the alighting passenger, and
providing a reservation information storage means for storing reservation information associating a name of the person making reservation for the said shared vehicle, date and time of boarding, boarding point, date and time of alighting and alighting point,
receiving reservation information consisting of a name of a person making reservation, date and time of boarding, a boarding point, date and time of alighting and an alighting point and storing the received reservation information in the said reservation information storage means,
calculating a route capable of an operation based on the said reservation information stored in the said reservation information storage means, and generating an operation schedule consisting of date and time of boarding/alighting, a stopping point, a name of boarding passenger and a name of alighting passenger for following the calculated route, and storing the generated operation schedule in the said operation schedule storage means,
receiving boarding/alighting information sent from the said information terminal apparatus consisting of the date and time of boarding/alighting, the stopping point, the name of the boarding passenger and the name of the alighting passenger,
determining whether or not the said name of the boarding passenger included in the said boarding/alighting information and the said name of the passenger stored in the said operation schedule storage means associated with the said date and time of boarding/alighting and the said stopping point match,
acquiring a notifying destination associated with the said name of the user corresponding to the said name of the passenger from the said notifying destination storage means and generating notification information addressing to the acquired notifying destination, including the fact that the passenger did not board according to the reservation, the said reservation information and the said boarding/alighting information, in the case where it was determined by the said boarding/alighting result determination step that the said names of the passenger do not match, and
transmitting said notification information generated in the said notification information generation step.
